(19) United States
(12) Patent Application Publication
(10) Pub. No.: US 2003/0198188 A1
(43) Pub. Date: Oct. 23, 2003

(54) Combined hardware and software architecture for remote monitoring

(76) Inventors: Michael J. Castlebury, Sheridan, CO (US); Forest W. Luke, Highlands Ranch, CO (US); Matthew J. Faulhaber, Highlands Ranch, CO (US)

Correspondence Address: THOMAS W. HANSON, LLC, 3990 S. CHEROKEE ST., ENGLEWOOD, CO, 80110, US

(21) Appl. No.: 10/126,181

(22) Filed: Apr. 20, 2002

(51) Int. Cl. H04J 1/16

(52) U.S. Cl. 370/252; 370/386

(57) ABSTRACT

A system for the monitoring of remote equipment or processes such as oil and gas wells. The system utilizes a local controller at each site which transmits data to a central server over a wide area network. Preferably, the local controller will be connected to the wide area network via a wireless radio frequency connection. The central server then provides the stored data to users via served web pages or custom software viewable on any compatible computer attached to the network. The users of the system can also enter data values into web pages on the viewing computer to be transferred through the system to the local controller to alter its operation or that of the equipment to which it is attached.

### CROSS-REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

1. Field of the Invention

The present invention relates to the field of distributed communications systems and specifically to such systems used to monitor remote, distributed equipment or production systems.

2. Background Information

Many industries, including oil and gas, are faced with the problem of monitoring production facilities and other equipment which are distributed over a wide geographic area. In the case of oil and gas well production, a single production office may have responsibility for many fields and hundreds of wells spread across hundreds of square miles. The most common approach to the monitoring problem is to have personnel physically visit each site periodically, as often as daily, to adjust equipment settings and record data which are then used by the production office to modify operational parameters at each well. Because of the travel time involved, the production office is often working with data that is 12-24 hours old and operational changes may lag a day or more behind a change in conditions. This can have significant adverse effects on productivity and efficiency. Further, alarms resulting from operational upsets may not be noticed until the next visit during which time equipment may be shut down, or may be damaged.

Remote monitoring systems exist to supplement or replace human monitoring. A typical system would be a SCADA based central server solution. Monitoring equipment at the remote sites are connected to the central server. The central server polls the monitoring equipment, retrieves their data, and stores it. This data can then be retrieved from the central server by users of the system for display on monitors or local computers.

The connection between the server and the monitoring equipment is typically serial, utilizing phone line, cable, or wireless connections. These connections are typically half-duplex and actively polled under the control of the central server. In particular, the wireless connections are generally slow and range limited. These connections result in bandwidth restrictions as well as timing concerns. Since the polling is under the control of the central server, a remote monitor can not asynchronously report a problem or alarm until polled. This communications approach also provides little, if any, capability to interactively query or reconfigure the remote equipment.

The data viewing service provided by the server also suffers from a bandwidth and performance limitation. The centralized approach typically means that the server retrieves the data, formats the reports, and generates the graphics requested by the user. The formatted reports and graphics are then transmitted to the users monitor or computer, either requiring very high bandwidth or providing very poor performance. Much of this performance problem is due to the need to transmit the graphical displays which are data intense.

A further problem with the typical prior art approach is that at least some of the architecture components are proprietary. This limits the number of potential sources of supply, driving up costs, and incurring the risk that a sole source vendor may stop supporting a needed product.

There is a need for an improved automated, remote monitoring capability which provides an open architecture, non-proprietary solution. The solution should include high bandwidth, full duplex wireless connections which support real time communication and interactive querying and reconfiguration of the remote monitoring equipment. Communications should be driven by the remote equipment to allow asynchronous reporting of alarm conditions and as-needed data reporting. Data display and reporting would preferably distribute the report and graphics generation functionality to the user's computers, allowing only the required data to be transmitted. Ideally, the system would utilize existing WANs, such as the Internet for connectivity, and would provide access from conventional, non-dedicated PC class computers.

### BRIEF SUMMARY OF THE INVENTION

The present monitoring system invention provides an open architecture solution which leverages Internet and world wide web technology to provide interactive remote monitoring capability. Combining wireless connectivity with a wide area network, such as the Internet, the system allows users throughout the world to keep track of equally widely distributed production sites. High bandwidth, full duplex communication removes previous data bottlenecks while data reporting triggered by the local controller at the remote site improves timeliness and may save bandwidth by transmitting only when needed rather than on a fixed schedule.

According to the invention there is provided a central data store and web server connected via WAN to local controllers sited near the remote equipment. Data is transferred to and stored on the server for access. Any properly authenticated computer on the network can then retrieve data from the server for display to the user.

According to an aspect of the invention a wireless connection, such as a radio frequency modem, couples the local controller to the WAN for simplified connectivity and siting. According to another aspect of the invention the local controller has its own non-volatile storage and the capability to cache data if the connection to the server is lost. The cached data is automatically transmitted when the connection becomes available.

Further in accordance with the invention, data can be input at the display computer and routed through the server to the local controllers to reconfigure their operation or that of the equipment they are monitoring.

Still further in accordance with the invention, graphical components and display software are pre-loaded on the display computer so that only the data itself need be transmitted in order to present a display to the user.

The advantages of such an apparatus are a flexible, high speed system which is free of proprietary products and leverages existing technology and applications already in use for other purposes.

The above and other features and advantages of the present invention will become more clear from the detailed description of a specific illustrative embodiment thereof, presented below in conjunction with the accompanying drawings.

### BRIEF DESCRIPTION OF THE SEVERAL VIEWS OF THE DRAWINGS

FIG. 1 depicts the top level hardware architecture of the inventive system.

FIG. 2 is a block diagram of the data capture device component.

FIG. 3 is a block diagram of the local controller component.

FIGS. 4A&B are block diagrams of the data transport device components.

FIG. 5 is a block diagram of the central server component.

FIG. 6 is a block diagram of the end user computer component.

FIG. 7 depicts the top level software architecture of the system.

FIG. 8 illustrates the end-to-end data flow through the system.

FIG. 9 is a flow chart illustrating the control flow of the local controller client.

FIG. 10 is a flow chart illustrating the control flow of the web server handling the data collection task.

FIG. 11 is a flow chart illustrating the control flow of the web server handling the task of serving web pages and data.

FIG. 12 illustrates the interaction and message sequencing between the various entities involved in a user login and display session.

### DETAILED DESCRIPTION OF THE INVENTION

The following discussion focuses on the preferred embodiment of the invention, in which it is used to monitor a well field or similar production site. However, as will be recognized by those skilled in the art, the disclosed method and apparatus are applicable to a wide variety of situations in which remote monitoring of production, process control, or other equipment is desired.

Glossary

The following is a brief glossary of terms used herein. The supplied definitions are applicable throughout this specification and the claims unless the term is clearly used in another manner.

ASP—Active Server Page.

HTML—Hypertext Markup Language.

WAN—Wide Area Network.

XML—Extensible Markup Language.

Preferred Embodiment

The disclosed invention is described below with reference to the accompanying figures in which like reference numbers designate like parts. Generally, numbers in the 200's refer to prior art elements or elements in the surrounding environment while numbers in the 100's refer to elements of the invention. Numbers in the 300's are used to designate processing steps implemented by the invention.

Overview

The present invention is a system for remote monitoring of equipment and/or processes. A typical application would be monitoring oil and gas production wells. These wells are typically distributed across oil or gas fields spanning large geographic areas. A single production office may have responsibility for many fields and hundreds of wells spread across hundreds of square miles. Each of these wells may have in place smart end devices, such as meters and valves, which are capable of communicating with a microcomputer or the wells can be equipped with data capture devices which can monitor “dumb” end devices incapable of operation. A local controller gathers information from one or more wells and periodically uploads this information to a central database where it is immediately available for end user analysis. The various components of the system are tied together via the Internet or other WAN. Preferably the local controllers connect to the network via a wireless bridge using a radio or satellite connection to a more centrally located wired connection to the network. The end users utilize tailored network applications to retrieve database entries from any network connected computer. Control information can then be entered into the database for transmission to the local controllers to update operational parameters for the wells.

Hardware Architecture

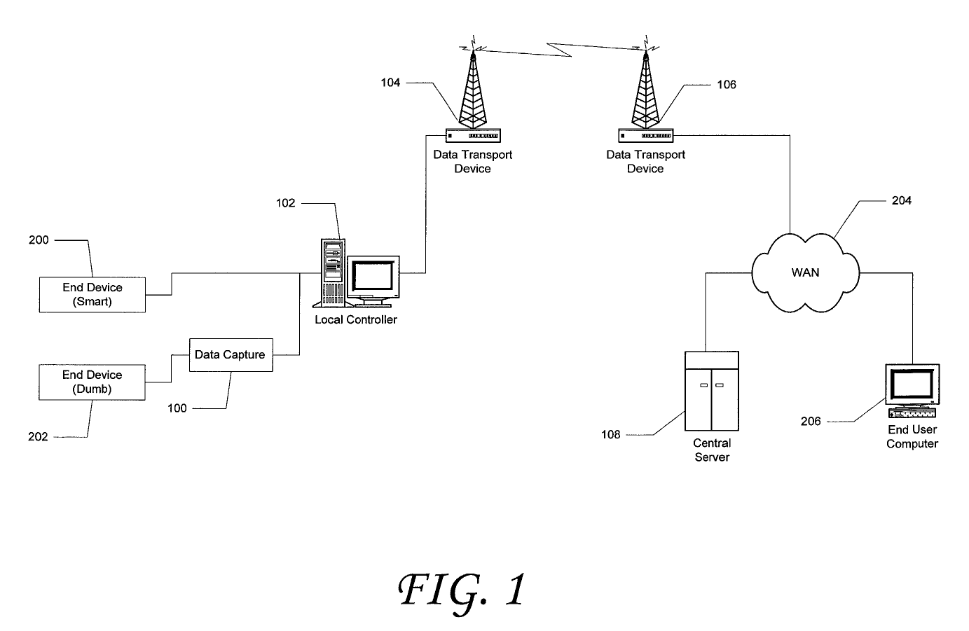

FIG. 1 provides a top level view of the hardware architecture of the present invention. Smart and dumb end devices, 200 and 202, are outside the system and connect directly to the remote equipment being monitored. A smart end device will connect directly to a local controller, 102, via a serial, parallel, or similar communications interface. A dumb end device will be instrumented and those instruments connected to a data capture device, 100, which then communicates with the local controller via an appropriate interface. The local controller is also connected to a data transport device, 104, which provides wireless communication to a second data transport device, 106. The second data transport device is connected to the Internet, or other wide area network (WAN), 204. The WAN provides data communication between the various data transport devices and the central server, 108 as well as between the server and the end user computers, 206. In a typical installation there would be a relatively large number of data transport devices connected to the WAN and there may be multiple servers as necessary to support the processing load. If desired, the servers may be shared among multiple customers.

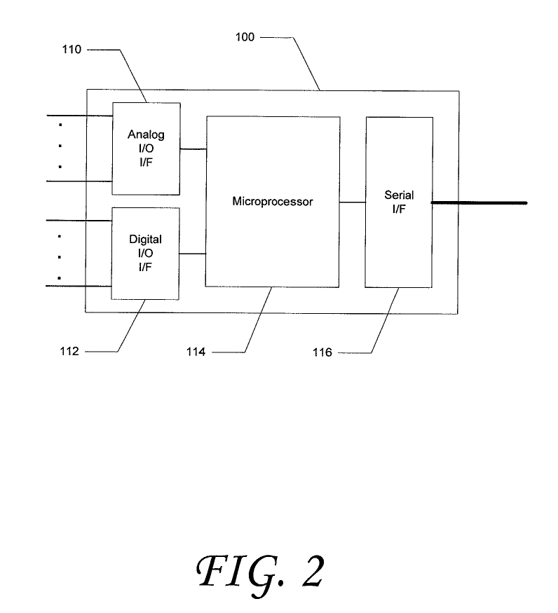

FIG. 2 is a more detailed illustration of a data capture device. As described above, this device is used where the existing end user devices lack the necessary data communications capability. Analog and digital input/output interfaces, 110 and 112, provide the ability to communicate with monitoring and/or control equipment to be attached to the end user device. These interfaces may support any one or more communications protocols as appropriate to the specific application. Serial interface, 116, provides a data connection to the local controller for two way transfer of data. While preferably a serial connection, clearly other protocols would also be applicable. Microprocessor, 114, handles the coordination and interchange of data between the various communications interfaces.

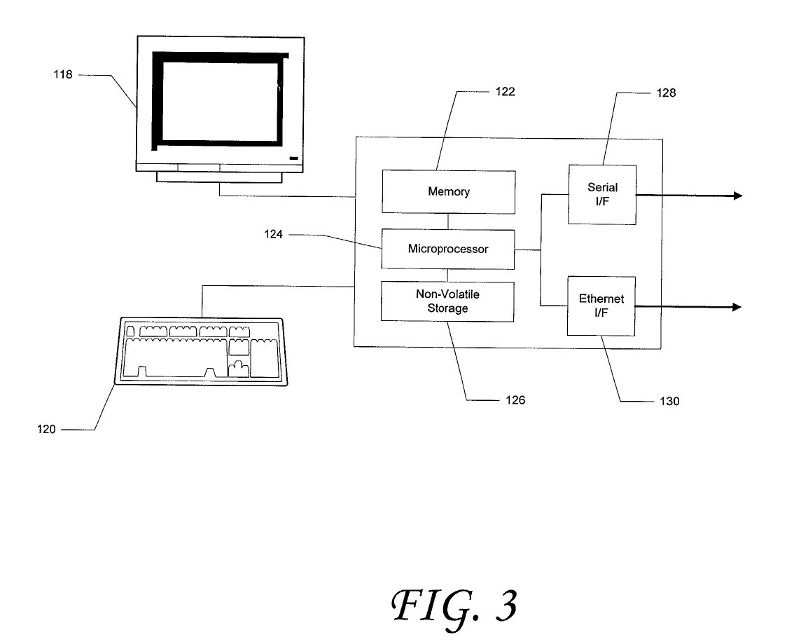

The local controller is illustrated in FIG. 3. This is typically a conventional personal computer class system, possibly hardened as needed for the operational environment. Monitor, 118, and keyboard, 120, are used when direct access by a user is required. These may be optional or removable, for use only when needed. The processing portion of the local controller comprises a micro processor, 124, memory, 122, and non-volatile storage, 126, such as a magnetic or optical drive. These components provide the processing necessary for data collection and buffering for the connected end devices and the transfer of data over the WAN. In the preferred embodiment processing is provided by an Intel x86 complaint processor running a Microsoft Windows CE or Windows 2000 operating system. Serial interface, 128, provides the two-way connection to the end devices and/or data capture devices. As discussed above, protocols other than serial could also be used. Multiple interfaces could be used as needed depending on the protocol and the number of devices to be connected. Ethernet interface, 130, provides a data connection to the data transport device. In the preferred embodiment, this connection is a conventional Ethernet connection supporting TCP/IP and/or PPP protocols. One advantage of this selection, in combination with the fact that the data transport devices operate as bridges, is that the local controllers are IP addressable and can be directly accessed over the WAN, greatly simplifying the communications task.

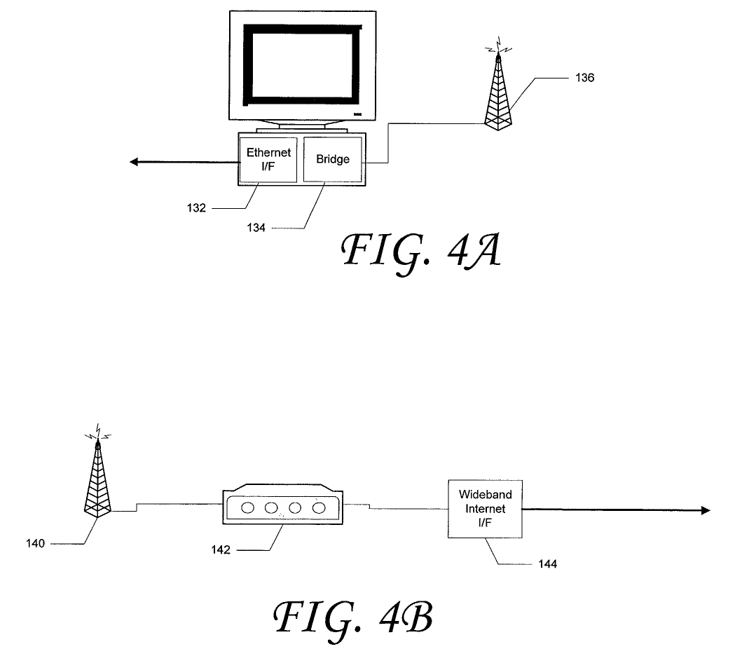

The data transport devices exist in two slightly different configurations as illustrated in FIGS. 4A and 4B. The configuration of FIG. 4A comprises computer, 138, hosting an Ethernet interface, 132, and wireless bridge, 134, connected to an external antenna, 136. This configuration corresponds to element 104 of FIG. 1 and is adapted to communicate with one or more local controllers via the Ethernet interface. The external antenna serves to extend the range of the wireless bridge to the distances required for access from the remote equipment locations. Optimally, these distances can exceed 40 miles. In the preferred embodiment the wireless bridge is an Aironet series bridge available from Cisco Systems, Inc. which provides IEEE 802.11b compliant direct sequence spread spectrum (DSSS) connectivity. The WAN-side configuration of FIG. 4B corresponding to element 106 in FIG. 1 is similar in functionality but differs in interface capability. As above, a wireless bridge, 142, with external antenna, 140, is used but here the bridge connects to a wideband interface, 144, such as a router, which provides connectivity to the WAN. Because of the equipment configuration, a computer is not required. It could also be eliminated from the configuration of FIG. 4A if a stand-alone bridge is available. In the preferred embodiment, the connection between the two data transport devices is full duplex, providing improved connectivity over a typical prior art system.

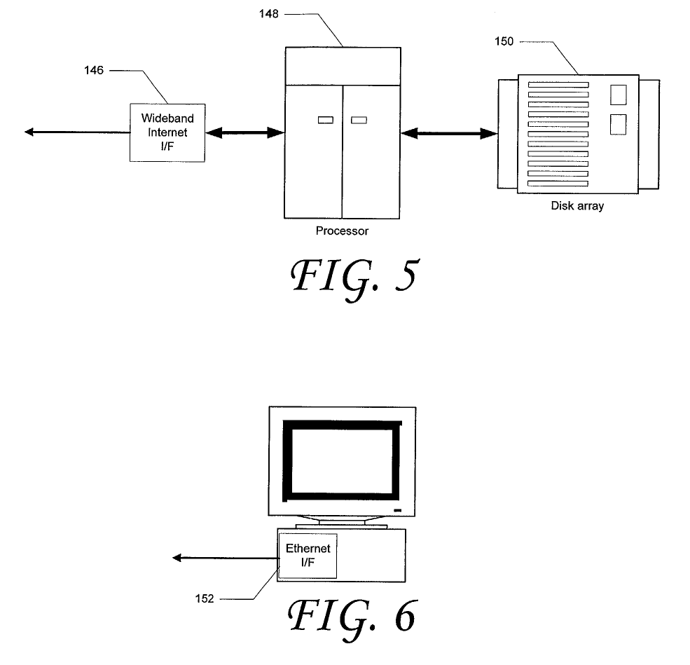

FIG. 5 illustrates the preferred configuration of the central server. This is preferably a conventional Internet web server comprising a processor, 148, wideband network interface, 146, and non-volatile storage array, 150. In size and complexity the server could range from a single processor with hard drive(s) to a multiple processor farm with redundant disk storage array as needed to support the user base. Regardless of configuration, the basics remain the same: a server connected to the WAN with the capability to store and retrieve data, preferably using a database.

From a hardware perspective, the end user computer, FIG. 6, can be any conventional computer with an network interface, 152, which supports access to the Internet or other WAN being used. The network interface may be an Ethernet interface connected to a LAN which is in turn coupled to the WAN or it may be a modem for dial in capability. The exact interface in not important and this provides a great deal of flexibility in user connectivity.

Software Architecture

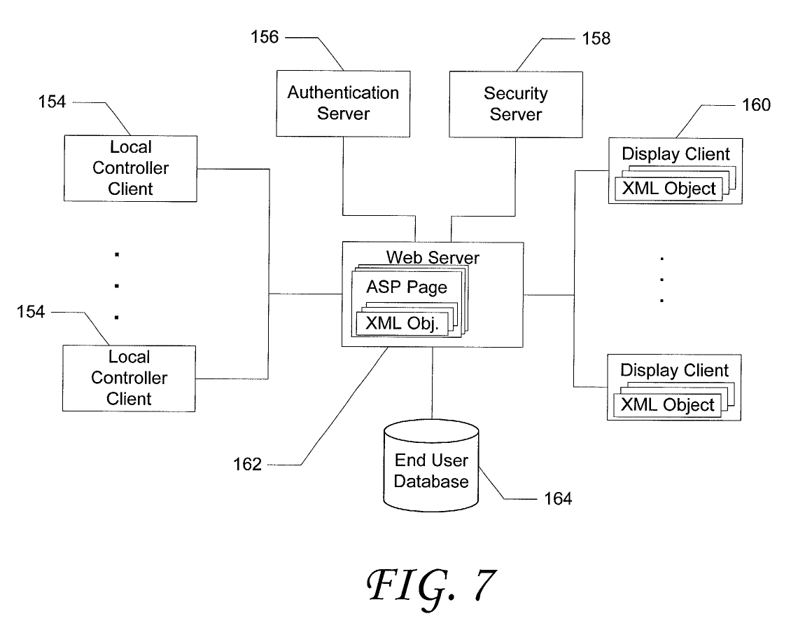

The software components of the system are illustrated in FIG. 7. Central to the system is the web server, 162. In many ways, this is a conventional secure web server as might be used to host any Internet web site. It has the ability to serve HTML and ASP web pages to those clients which request them. This capability is used to provide data for display on the end user display clients, 160. Served pages also provide the mechanism by which data is transferred from the local controller clients, 154, to the web server for storage. In both cases, a set of web pages are provided on the server which contain embedded XML objects and/or server side scripts. These objects contain software functions which access the end user database, 164, to store or retrieve data as appropriate. A similar approach is used to send control information to the local controller clients by reading the information from the database.

The local controller clients, 154, reside on the local controllers, 102 in FIG. 1, and provide services to the remote equipment site. These services include acquisition of data from the end devices; download of control parameters to the end devices; and remote diagnosis or trouble shooting under end user control. The local controller client is a custom software application which handles communication with the end devices and data transport device, 104 in FIG. 1, and also uses protocols developed for web browsers to communicate with the web server, 162. By requesting web pages from the server as if it were a browser, the local controller causes the web server to retrieve, format and transmit web pages. Data to be sent to the database by the local controller is packaged as if a user had entered it into one of the received web pages containing input fields or an input form and the web page is parsed by the web server. Where the server needs to transmit data (such as control data) to the local controller, it formats and transmits one or more web pages incorporating embedded data from the end user database. Upon receipt, these pages are parsed and the embedded data stripped out for use by the local controller. This approach of using standard web browser protocols decreases the cost of development by leveraging existing server technology and avoiding the expense of developing a custom server. The local controller also includes the capability to archive data locally when the web server is unreachable. That archived data is then transmitted at a later time when communications is reestablished.

The end user display clients, 160, reside on the end user computers, 206 in FIG. 1, and provide display services to the end user. Preferably the end user display client is a Macromedia Flash executable which has been customized for each customer, but is common across all end user computers for the same customer. The executable can be downloaded to any computer by an authorized computer, allowing user interaction on any compatible computer which is attached to the WAN. XML objects embedded within the executable then handle the retrieval of data from the end user database, 164, and the display of that data to the end user. Initial interaction with the web server, to obtain the customized executable, is handled by a conventional web browser such as Microsoft Internet Explorer version 5.0 or greater.

The authentication server, 156, handles the authentication of the end user at the start of a session. The server may use one or more types of authentication ranging from simple passwords to biometric data as specified by the customer. The security server, 158, then validates a request from an authenticated user to access the end user database, 164, taking into consideration factors such as the number of simultaneous users (seats) allowed. A candidate authentication system is the SmartPath™ product from Authentor Systems, Inc.

Operation

Conceptually, the operation of the inventive system can be divided into two broad areas: the gathering of data from the remote sites; and the dissemination of this data to the distributed users. While the web server, 162 in FIG. 7, plays a central role in both areas it is also a substantially passive participant in both. This is because the present invention utilizes a distributed client-server approach which differs markedly from the centralized polling approach typified in the prior art.

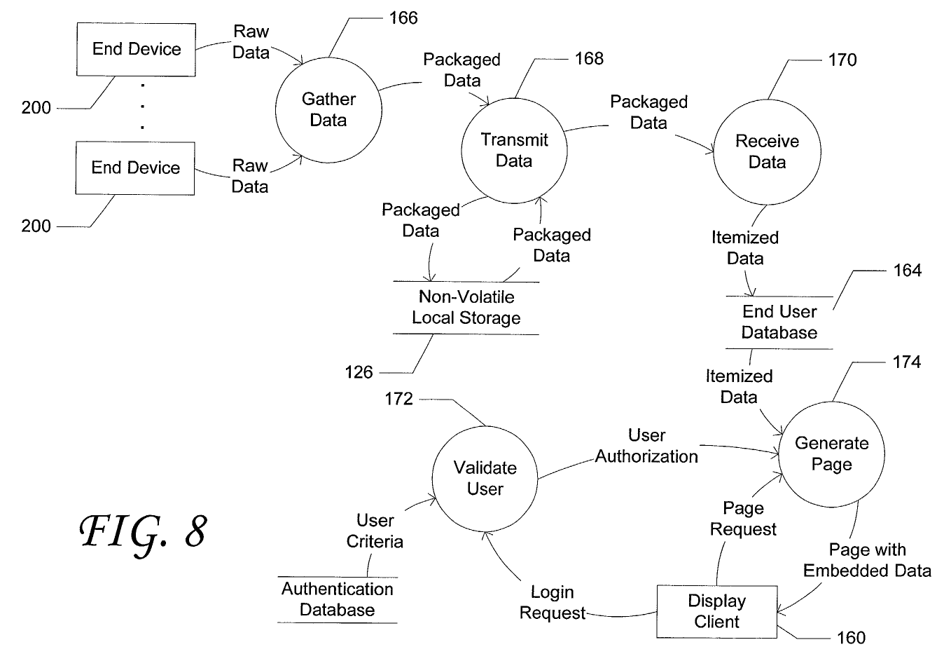

The data flow diagram of FIG. 8 provides a top level view of how the data moves through the system. Raw data is created by the end devices, 200, and gathered, 166, or acquired by the local controllers. This data is packaged together and transmitted, 168, to the web server. If communications can not be established with the web server for any reason, the packaged data is stored locally, 126, and later retrieved and transmitted. The web server receives the data, 170, and stores it in the end user data base, 164. This data base accumulates data until it is used by the end users or purged as desired. When an end user desires to view the accumulated data, the display client, 160, is activated and the user logged in through a validation and authentication process, 172. The validated display client then requests web pages from the web server. The server generates the page, 174, including embedding data from the end user database which is referenced by the page. The page is then sent to the display client for display to the user. This is a greatly simplified overview of the process. Additional details of various steps are discussed further below.

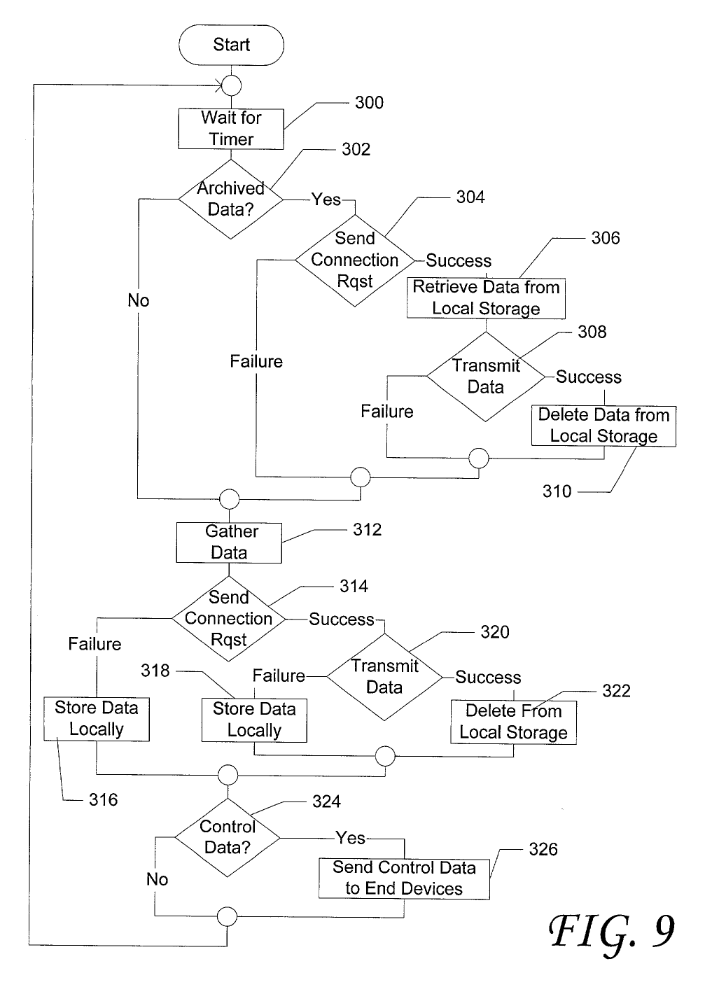

The high level processing of the local controller client is illustrated in the flow chart of FIG. 9. The local controller operates on a periodic timer which activates each iteration of processing, step 300. At the start of each iteration, the local controller checks for data archived by a previous iteration, 302. This would have occurred if a transfer could not have been completed previously. If such data exists, the local controller attempts to establish communications, 304, with the web server. In the preferred embodiment, this is done by requesting a specific web page from the server. If communications is successfully established, the archived data is retrieved, 306, and transmitted, 308, to the server. If the transmission is successful the archived data is deleted from local storage, 310. If either the communications could not be established or the transmission of the data failed, the data is left in storage and processing continues.

After dealing with archived data, the local controller client polls the attached end devices, or their data capture devices, and gathers their most recent data, step 312. With the data acquired, the local controller attempts to establish communication with the web server. As above, this involves requesting a specific page from the server. If communication can not be established the data is stored, 316, in local non-volatile storage for transmission at a later time. If communication is established, the data is packaged to appear like user input to the requested web page and transmitted to the web server, 320. Here again, if the transmission fails the data is stored, 318, for later transmission. If the transmission succeeds, the data is deleted, 322.

At the conclusion of the data transfer, the web server has an opportunity to send control data to the local controller client. As with the other communications, this is preferably handled by embedding the data in a web page which is parsed by the local controller. If control data is sent, 324, it is extracted and sent, 326, to the appropriate end devices.

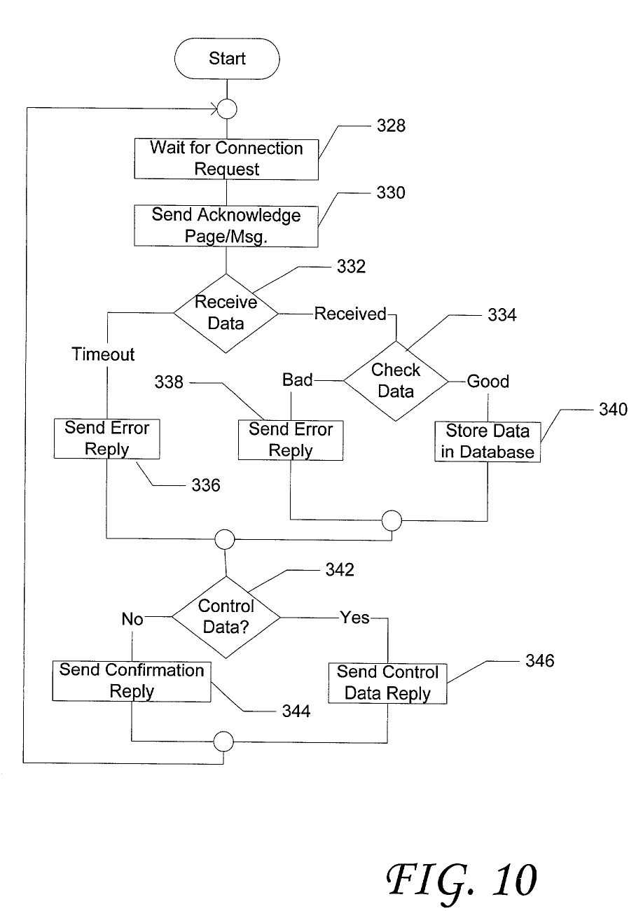

The web server side of the data gathering process is illustrated in FIG. 10. Note that the server may well be performing other tasks in parallel. This view is only of the data receiving process. The process is initiated upon receipt of a request, step 328, from one of the local controller clients. In the preferred embodiment, this is a request for a web page available from the server. The requested page is sent back, 330, to the local controller as an acknowledgment. This serves to tell the local controller that communications has been established and it is “OK to send” the data. Upon receipt, 332, of the data from the local controller the data is checked for validity, 334. If valid, the data is stored, 340, to the appropriate end user database. Note that in the preferred embodiment, a single web server may be providing services for more than one customer, or end user. Part of the customer logging process authenticates access to the correct end user data base. If the data does not pass validation an error message is sent, 338, to the local controller. If no data is received within a predetermined time period, a timeout condition occurs and an incomplete transmit page is sent, 336, to the local controller.

Once the data receive process for a particular local controller client has completed, the web server will check, 342, to see if control data is available for transmission to that local controller. This control data is available from the end user database and may have been stored there through the display client, by a system administrator or tester, or by any other authenticated means. If control data is available, it will be packaged into the confirmation message and sent, 346, to the local controller. If no data is available a simple confirmation message with no data will be sent, 344.

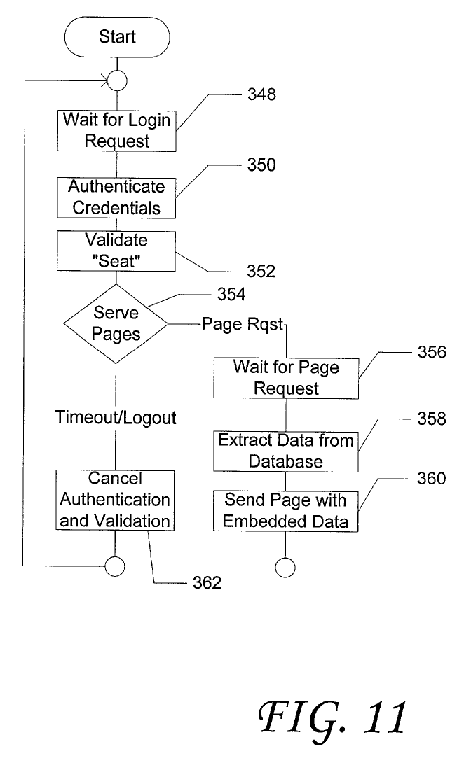

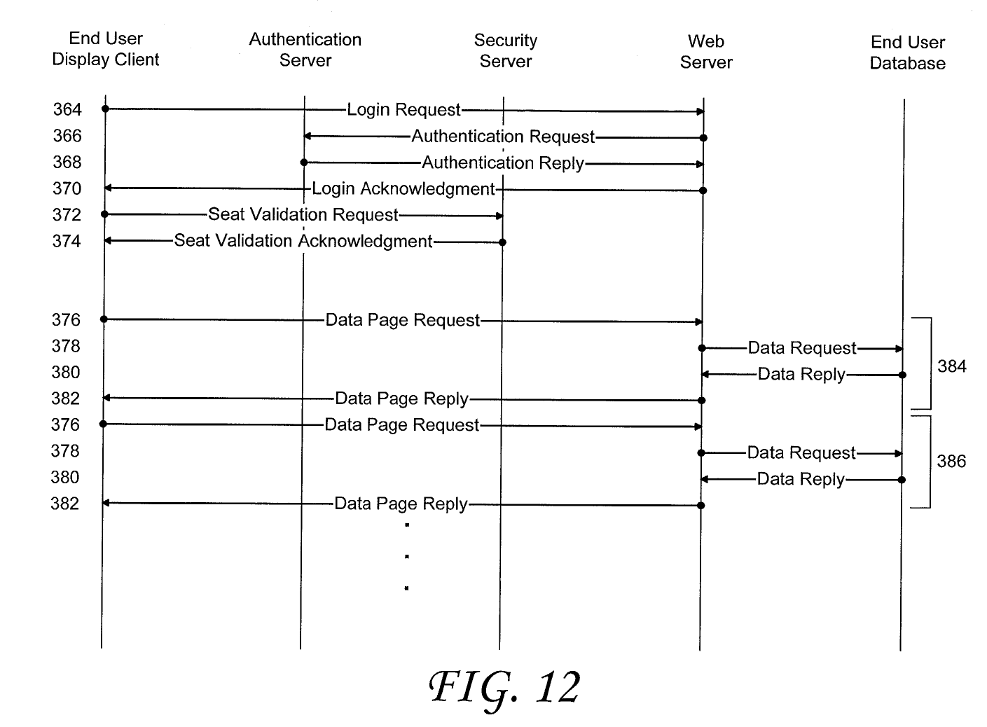

The web server also retrieves data from the end user data base and transmits it to display clients as illustrated in FIG. 11. As data requests are accepted from any compatible computer attached to the associated WAN, users must be authenticated and validated before being granted access to the system. Authentication, 350, involves establishing the identity of the user attempting to access the system and may involve the use of passwords, biometrics, or other approaches. Validation, 352, then confirms that the connection is allowed considering the number of permitted connections and other configuration factors. This process is illustrated in more detail in the interaction diagram of FIG. 12. With the user authenticated and validated, the web server will then serve, 354, web pages to the end user until the user logs out or the session times out, 362. During a session, the server waits, 356, for a page request from the user; retrieves, 358, that page and populates it with data from the data base; and sends, 360, the page and its embedded data to the user's display client for presentation. In the preferred embodiment data retrieval and embedding is handled through the use of active server pages, XML objects embedded within the web pages, and server side scripts as is well known in the industry.

The interaction diagram of FIG. 12 illustrates the high level communication and message sequence involved in a user establishing a session with the inventive system and then retrieving data. Note that error conditions and processing have been omitted for clarity. The process is initiated by a login request, 364, from the user to the web server. In response, the web server sends an authentication request, 366, to the authentication server. The authentication server will then exchange one or more sequences of messages with the display client (not shown) to authenticate the user's identity. Once the user's identity has been established to the satisfaction of the authentication server, an authentication reply, 368, is returned to the web server so that it can continue processing. Once the user is authenticated, the web server acknowledges the login request, 370, and the display client sends a seat validation request, 372, to the security server. If the request is valid, the security server responds to the display client with a validation acknowledgement, 374. At this point the user has been authenticated and validated and a session established between the display client and the web server. The user, via the display client, can then request one or more data pages from the web server. Each of these requests comprises a series of messages such as 384. The initial message, 376, is a request from the display client to the web server for a specific data page. Where this page contains embedded references to data in the end user data base the web server will send one or more requests, 378, to the data base which responds with the requested data, 380. This data is merged into the web page and the page sent to the display client, 382. This sequence is repeated for each page requested by the client until the session is terminated.

Alternative Embodiments

The following discussion presents alternative embodiments which offer various advantages in structure or functions without departing from the principles of the invention.

An alternative embodiment of the present invention utilizes satellite uplink/downlink in place of the radio connection between the data transport devices, 104 and 106 in FIG. 1. This may be done in at least two different ways. First, each site could have its own satellite uplink capability, with the system architecture essentially unchanged. Second, wireless or wired connections could be used to link two or more remote sites to a single satellite uplink. This would concentrate the data traffic and spread the cost of the satellite facilities across a larger number of sites for greater cost effectiveness. Since the satellite uplink/downlink would be bi-directional and functionally equivalent to the radio link, all capabilities of the system would remain unchanged, including the IP addressability of the local controller, data capture devices, and smart end devices at the remote site.

Another alternative embodiment would utilize a dial-up connection over convention telephone lines. The local controller would include a modem and an auto-dialer. When a connection is desired, the local controller would dial a pre-selected Internet Service Provider, and login using a configured account and password to gain access to the Internet.

While the preferred form of the invention has been disclosed above, alternative methods of practicing the invention are readily apparent to the skilled practitioner. The above description of the preferred embodiment is intended to be illustrative only and not to limit the scope of the invention.

I/We claim:

1. A system for the remote monitoring of equipment, said system comprising:
(a) a central server having non-volatile storage capability;
(b) at least one local controller having at least one data connection to the equipment being monitored and in data communication with said central server, said data communication comprising bi-directional data transmission via a general purpose wide area network;
(c) at least one end user computer in data communication with said central server, said data communication comprising data transmission via a general purpose wide area network;
(d) wherein said local controller periodically transmits data to said central server via said data communication and said data is stored by said central server using said non-volatile storage capability.

2. The monitoring system of claim 1 wherein said data communication between said local controller and said central server comprises a wireless, full-duplex connection.

3. The monitoring system of claim 2 wherein said wireless connection is interposed between said local controller and said wide area network and wherein said local controller is addressable as a device on said wide area network.

4. The monitoring system of claim 1 wherein said local controller further comprises non-volatile storage and said local controller caches said data in said storage in the event that said data communication with said server is unavailable at the time of said periodic transmission.

5. The monitoring system of claim 4 wherein said local controller automatically transmits said cached data as a part of the next of said periodic transmissions at which said data communication is available.

6. The monitoring system of claim 1 wherein said local controller is responsive to at least one control parameter and wherein said control parameter can be modified by said end user computer.

7. The monitoring system of claim 6 wherein said modification of said control parameter comprises transmission of a modified value from said end user computer to said central server and retransmission of said modified value from said central server to said local controller.

8. The monitoring system of claim 1 further comprising a pre-loaded display program executing on said end user computer, said display program comprising plural graphical display components responsive to data values retrieved at a later time from among those stored by said central server.

9. A system for the remote monitoring of equipment, said system comprising:
(a) a web server software application providing data storage, data retrieval and web page serving services;
(b) at least one local controller client, communicating with said web server, adapted to retrieve monitor data from the monitored equipment and to transmit said data to said web server for storage;
(c) at least one display client, communicating with said web server, adapted to retrieve said monitor data from said web server and display it visually.

10. The monitoring system of claim 9 wherein said local controller client and said display client each comprises a different software application executing on a different general purpose computer.

11. The monitoring system of claim 10 wherein at least one of said data communication between said local controller client and said web server and between said display client and said web server comprises retrieval of a web page comprising an embedded executable object which interacts with said web server data storage.

12. The monitoring system of claim 9 wherein said local controller client is further adapted to temporarily cache said monitor data when unable to communicate with said web server immediately after retrieving said monitor data.

13. The monitoring system of claim 12 wherein said local controller client automatically transmits said cached monitor data when again able to communicate with said web server.

14. The monitoring system of claim 9 wherein said local controller client is responsive to at least one control parameter and wherein said display client is further adapted to retrieve, modify, and store said control parameter.

15. The monitoring system of claim 9 wherein said local controller communicates with said web server via a general purpose wide area network and said display client communicates with said web server via the same said general purpose wide area network.

16. The monitoring system of claim 15 wherein said local controller client further communicates with said web server via a wireless radio frequency connection interposed between said local controller and said general purpose wide area network.

17. The monitoring system of claim 16 wherein said local controller client is directly addressable as a device on said general purpose wide area network.

18. The monitoring system of claim 9 further comprising an authentication server in communication with said web server and said display client, adapted to authenticate access of said monitor data, stored by said web server, by said display client.

19. The monitoring system of claim 18 further comprising a security server in communication with said web server and said display client to validate access by said display client to the services of said web server.
